(19) United States
(12) Patent Application Publication
(10) Pub. No.: US 2025/0139653 A1
(43) Pub. Date: May 1, 2025

(54) Management System

(71) Applicant: Hitachi Industrial Equipment Systems Co., Ltd., Chiyoda-ku, Tokyo (JP)

(72) Inventors: Makiko NAEMURA, Tokyo (JP); Youji IKEDA, Tokyo (JP); Yuusuke NAKAGAWA, Tokyo (JP)

(21) Appl. No.: 18/835,598

(22) PCT Filed: Jan. 26, 2023
(86) PCT No.: PCT/JP2023/002453

§ 371 Date: Aug. 2, 2024

(30) Foreign Application Priority Data
Feb. 3, 2022 (JP) 2022-015941

(51) Int. Cl. G06Q 30/0208; G06Q 30/0601

(52) U.S. Cl. CPC G06Q 30/0208; G06Q 30/0643

(57) ABSTRACT

A management system includes: a measurement data acquisition unit that acquires measurement data, the measurement data being time-series data related to operation of a device; an index computation unit that computes an index based on the measurement data; a credit calculation unit that compares the index before and after a change is made to the device and calculates credits as compensation for reducing an emission of greenhouse gas; and a credit management unit that associates part of the calculated credits with a user of the device. The credit management unit associates part of the calculated credits with an operator of the management system or a producer of the device.

### TECHNICAL FIELD

The present invention relates to a management system.

### BACKGROUND ART

Addressing of environmental issues, particularly reduction of greenhouse gas emission, is increasingly important in corporate activities. Patent Literature 1 discloses a method of assisting in carbon offsetting activities, including the steps of: receiving an order for supply items which indicate that they are products or services contributing to carbon offsetting from a user terminal; calculating a corresponding amount of greenhouse gas offset on the basis of an applied carbon offset amount per supply item and the number of supply items ordered in the order received in the preceding step; allocating a specific code to the amount of greenhouse gas offset calculated in the preceding step on the basis of a serial number assigned to a greenhouse gas reduction value purchased from a provider; and issuing a carbon offset certificate indicating the specific code allocated in the preceding step.

### CITATION LIST

### Patent Literature

[Patent Literature 1] Japanese Patent Laid-Open No. 2012

### SUMMARY OF INVENTION

### Technical Problem

The invention described in Patent Literature 1 is intended to calculate the amount of greenhouse gas offset from the ordered supply items and the number of orders upon ordering of supply items that indicate they are products or services contributing to carbon offsetting, and does not take into account how the greenhouse gas and/or energy consumption arising from the manufacture of the supply items or manufacturing apparatuses therefor actually changes. That is, it does not consider collecting data necessary for calculating the emission of greenhouse gas or energy consumption that arises from the use of an apparatus or a device. The reduction effect is also limited because the cited invention lacks a mechanism to encourage various stakeholders to participate in contribution to environmental value. An object of the present invention is to attain a system that enables facility users and producers to work to suppress the emission of greenhouse gas continuously and effectively.

### Solution to Problem

A management system according to a first aspect of the present invention includes: a measurement data acquisition unit that acquires measurement data, the measurement data being time-series data related to operation of a device; an index computation unit that computes an index based on the measurement data; a credit calculation unit that compares the index before and after a change is made to the device and calculates credits as compensation for reducing an emission of greenhouse gas; and a credit management unit that associates part of the calculated credits with a user of the device. The credit management unit associates part of the calculated credits with an operator of the management system or a producer of the device.

### Advantageous Effect of Invention

According to the present invention, incentive to reduce the emission of greenhouse gas also arises for various stakeholders, including device users. In turn, it can promote reduction in emission of greenhouse gas on a continuous basis.

### BRIEF DESCRIPTION OF DRAWINGS

FIG. 1 is a block diagram of a management system.

FIG. 2 shows an example of a credit information DB.

FIG. 3 shows an example of an operation information DB.

FIG. 4 shows an example of a device information DB.

FIG. 5 shows an example of a contract information DB.

FIG. 6 shows an example of an improvement detection DB.

FIG. 7 shows an example of an account DB.

FIG. 8 shows an example of a credit issuance eligibility DB.

FIG. 9 is a flowchart illustrating operations of a device change processing unit.

FIG. 10 shows a main screen generated by a UI generation unit.

FIG. 11 shows a component order screen generated by the UI generation unit.

FIG. 12 shows a maintenance history screen generated by the UI generation unit.

FIG. 13 shows a screen generated by the UI generation unit.

FIG. 14 shows an agreement screen generated by the UI generation unit in a first variation.

### DESCRIPTION OF EMBODIMENTS

### First Embodiment

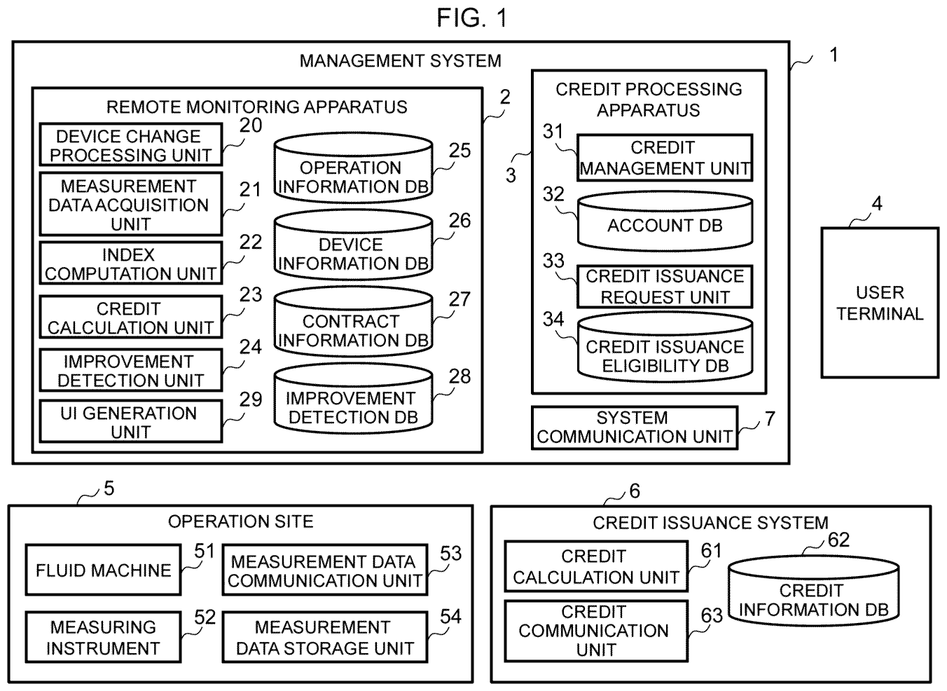

A first embodiment of the management system according to the present invention is described below with reference to FIGS. 1 to 13.

FIG. 1 is a block diagram of a management system 1. The management system 1 includes a remote monitoring apparatus 2, a credit processing apparatus 3, and a system communication unit 7. The remote monitoring apparatus 2 includes a measurement data acquisition unit 21, an index computation unit 22, a credit calculation unit 23, an improvement detection unit 24, a UI generation unit 29, an operation information database (hereinafter “operation information DB”) 25, a device information database (hereinafter “device information DB”) 26, a contract information database (hereinafter “contract information DB”) 27, and an improvement detection database (hereinafter “improvement detection DB”) 28. The credit processing apparatus 3 includes a credit management unit 31, an account database (hereinafter “account DB”) 32, a credit issuance eligibility database (hereinafter “credit issuance eligibility DB”) 34, and a credit issuance request unit 33.

The management system 1 uses the system communication unit 7 to communicate with a user terminal 4, an operation site 5, and a credit issuance system 6. The system communication unit 7 is a communication unit that implements wireless communication or wired communication. There may also be an apparatus for relaying communications. Although FIG. 1 depicts only one user terminal 4 and only one operation site 5 for the sake of illustration, the user terminal 4, the operation site 5, the management system 1 are typically connected with multiple user terminals 4 and operation sites 5. Each of the user terminal 4, the operation site 5 and the credit issuance system 6 may only be able to communicate with the management system 1; the user terminal 4, the operation site 5 and the credit issuance system 6 as third parties may not be able to communicate with each other.

The user terminal 4 can be a general-purpose computer, for example. The user terminal 4 has an input/output interface and a communication interface with the management system 1. In the description below, a human who operates the user terminal 4 will be called a “user”. The user is an owner of a fluid machine 51, discussed later.

The operation site 5 includes the fluid machine 51, a measuring instrument 52, a measurement data communication unit 53, and a measurement data storage unit 54. The measuring instrument 52, the measurement data communication unit 53, and the measurement data storage unit 54 may be configured integrally with the fluid machine 51, or only one measuring instrument 52, one measurement data communication unit 53 and one measurement data storage unit 54 may be provided for multiple fluid machines 51. The fluid machine 51 is a machine that uses the energy of fluid, such as an air compressor, a hydraulic motor, and a turbo pump, for example.

However, the operation site 5 may also be equipped with industrial devices that are used in industry fields other than that of the fluid machine 51. Such an industrial device can be a motor, an inverter, a device that contains an inverter and is controllable, a hoist or a crane for carrying objects, an air shower for removing dust at entry and exit into and from a food factory, a semiconductor test factory and the like, a safety cabinet and a clean bench used in a biotechnology-related facility, for example. The fluid machine 51 and such industrial devices will be collectively called just “devices” below.

The measuring instrument 52 acquires data on the operation of the fluid machine 51 at predefined time intervals and records the resulting values in the measurement data storage unit 54. The measuring instrument 52 records the mass flow rate, volume flow rate, discharge pressure and the like of fluid ejected by the fluid machine 51, for example. The measuring instrument 52 can be a pressure gauge or a flowmeter, for example. For an industrial device, the measuring instrument 52 would primarily record the current value, voltage value, amount of control of a power supply, the flow rate, pressure, torque, slip, and the number of revolutions on an output side. For the voltage value, the connected source voltage is known; thus, electric power may be determined using the current value and the known source voltage without measuring the source voltage. For an inverter, a current value and a voltage value for electricity that flows in a device connected with the inverter may be measured as measurement values on the output side. The fluid machine 51 will be used in the description below as a representative device.

The measurement data storage unit 54 is a storage apparatus. The measurement data storage unit 54 may be a volatile storage apparatus, but preferably is a non-volatile storage apparatus. Data on the operation of the fluid machine 51 recorded in the measurement data storage unit 54 can also be said to be time-series data because it is recorded at the predefined time intervals. The time-series data related to the operation of the fluid machine 51 that is recorded in the measurement data storage unit 54 will be called “measurement data” below. However, the measurement data is not necessarily the output of the measuring instrument 52 itself; it may be an arithmetic average, a weighted average, and a moving average, for example, and can be determined in other ways as long as it is in a form that allows for adequate utilization as measurement data.

The measurement data communication unit 53 is a communication interface that transmits measurement data recorded in the measurement data storage unit 54 to the remote monitoring apparatus 2 of the management system 1. The measurement data communication unit 53 may actively transmit measurement data to the remote monitoring apparatus 2 or may transmit measurement data at the request of the remote monitoring apparatus 2. The measurement data communication unit 53 may also transmit multiple pieces of measurement data at a time or may transmit a single piece of latest measurement data if the other measurement data have been already transmitted.

The credit issuance system 6 includes a credit calculation unit 61, a credit information database (hereinafter “credit information DB”) 62, and a credit communication unit 63. The credit issuance system 6 may be a single general-purpose computer or a computer cluster consisting of multiple computers. The credit calculation unit 61 issues credits on the basis of information received via the credit communication unit 63 and records them in the credit information DB 62. Credits are points that are granted as compensation for reducing the emission of greenhouse gas and are issued as electronic data.

The credit information DB 62 stores information on issued credits, e.g., information of the date and time of issuance, the quantity issued, and the issued-to party. In the present embodiment, a “credit ID”, which is an identifier created in advance by the credit issuance system 6, is used as the issued-to party of credits. Although credit is described here with the emission of greenhouse gas as a representative example, the emission of carbon dioxide, carbon equivalent weight, amount of energy consumption reduction or the like may also be used. Representative instances of such credits are Clean Development Mechanism (CDM) and Joint Crediting Mechanism (JCM), but credits that are conducted by an operator authorized by a government or a private business may also be used.

Although the present embodiment describes the credit issuance system as being recorded in a centrally managed database, it may also be managed by a block chain or a combination of a block chain and Non-Fungible Token (NFT) or Fungible Token (FT), for example. This enables distributed management of credits and verification of identity and also can increase the circulation of credits.

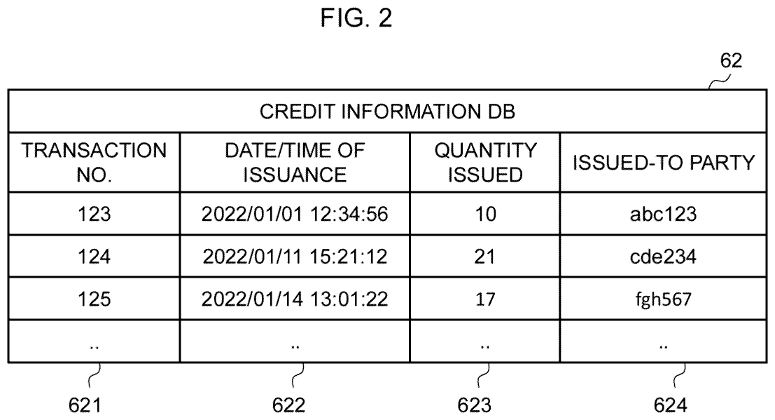

FIG. 2 shows an example of the credit information DB 62. The credit information DB 62 consists of multiple records, each record having the fields of transaction number 621, date/time of issuance 622, the quantity issued 623, and issued-to party 624. The transaction number 621 is a transaction number identifying a credit issuance transaction. The date/time of issuance 622 is the date and time credits are issued. The quantity issued 623 is the quantity of credits that are issued. The issued-to party 624 is the party to which the issued credits are granted, or in other words, a credit ID indicating the owner of the credits. The first two records in the example shown in FIG. 2 indicate that “10” credits were issued to the credit ID “abc123” at 12:34:56 on Jan. 1, 2022. Referring back to FIG. 1, description is continued.

The configuration of the remote monitoring apparatus 2 is now described. The measurement data acquisition unit 21 acquires measurement data from the operation site 5 and stores it in the operation information DB 25. The index computation unit 22 calculates an index indicating the power efficiency of the fluid machine 51 (hereinafter “power efficiency index”) with reference to the operation information DB 25. The power efficiency index can be the volume of fluid at a certain pressure that can be output using 1 kwh of power, for example. The credit calculation unit 23 calculates credits that the fluid machine 51 can obtain using the power efficiency index calculated by the index computation unit 22. The improvement detection unit 24 detects a possible improvement in relation to the operation of the fluid machine 51. The improvement detection unit 24 further calculates credits that would be obtained from the improvement using the index computation unit 22 and the credit calculation unit 23. The UI generation unit 29 generates a user interface for presenting the operation status of the fluid machine 51 and the detection result from the improvement detection unit 24 to the user.

The device change processing unit 20 performs predetermined processing when a change is made to a device managed by the remote monitoring apparatus 2. A change that is made can be exchange of a component of the device, overhauling of the device, a setting change to the device, or replacement of the device itself, for example. The fact that a change has been made to a device can be detected from processing that is based on information input from the user terminal 4, an update of the device information DB input from an administrator terminal (not shown in FIG. 1), a change in the detected value of the measuring instrument 52 read from the operation site 5, and configuration information for the device uploaded from the operation site 5. The predetermined processing performed by the device change processing unit 20 first determines whether the change made is eligible for issuance of credits or not in consideration of the credit issuance eligibility DB. If it is determined to be eligible for issuance, the device change processing unit 20 requests the credit issuance request unit 33 to issue credits based on the computation result from the credit calculation unit 23. The predetermined processing performed by the device change processing unit 20 has been described.

For example, the measuring instrument 52 determines a power consumption based on the current value or the like of the fluid machine 51, a power efficiency for the discharge pressure, or a predicted power consumption at that efficiency and the like in a predefined period prior to replacement of a component of the device or prior to overhauling of the device as a new reference value, and stores the determined new reference value in the measurement data storage unit 54. The predetermined period may be several days, several weeks, or several months. Subsequently, the measuring instrument 52 determines the power consumption based on the current value or the like of the fluid machine 51, the power efficiency for the discharge pressure, or the predicted power consumption at that efficiency and the like after the replacement of the component of the device or overhauling of the device, and stores a post-replacement comparison value to be compared with the new reference value in the measurement data storage unit 54. The new reference value can be handled as a baseline or a baseline emission determined by converting the power consumption to the emission of greenhouse gas. The post-replacement comparison value can be handled as a project emission that corresponds to the amount of execution of a project corresponding to a project certified by a certified operator or the amount of generated greenhouse gas. These new reference value and post-replacement reference value can be determined through computation at the operation site 5 after receiving data measured by the measuring instrument 52 stored in the measurement data storage unit 54 via the measurement data communication unit 53.

For a setting change to the device, the power consumption for the work of a certain amount of discharged fluid of the fluid machine 51 before the setting change is made can be used as a new reference value and the power consumption for the work of the certain amount of discharged fluid of the fluid machine 51 after the setting change is made can be used as the post-replacement comparison value, for example. Examples of a setting changes to a device include the case of updating to new firmware that allows for an operation method with a higher energy saving effect than before the setting change was made, the case of learning how the fluid machine 51 is used by the user and changing control to a more efficient operation method, the case where there are multiple fluid machines 51 and they cooperate with other fluid machines 51 to achieve more efficient operation, and the case of applying peak shift operation, for example. For a setting change to multiple machines that operate in coordination, measurements of the flow rate, the flow speed and the like of fluid flowing in a conduit measured by sensors may be used as measurement values on the output side.

If a changing action to the fluid machine 51 is replacement of the fluid machine 51 itself, measurement values of the amount of input power and the work of discharged fluid with the fluid machine 51 before replacement being installed can be compared as new reference values with the measurement values of the amount of input power and the work of discharged fluid with the fluid machine 51 after replacement being installed, thus calculating an index value related to environment improving effect.

The credit issuance request unit 33 transmits necessary information to the credit issuance system 6 and requests issuance of credits. Since different systems are used for different certified operators in the credit issuance system 6, information required for issuance of credits, applied rules, specifications and arrangements differ as well. Thus, the credit issuance request unit 33 can transmit information such as the new reference value and the post-replacement comparison value for the fluid machine 51 described earlier, the difference between the new reference value and the post-replacement comparison value, and the sampling period at which the difference was identified. The credit issuance request unit 33 does not have to request credit issuance in a strict sense, but may just provide information on evidence for issuing credits. The credit issuance request unit 33 can also transmit information on verification of additivity indicating that the fluid machine 51 will operate with respect to the new reference value.

In the case of replacement mentioned above, the credit issuance request unit 33 may further provide information on the rules, specifications and arrangements for calculating a saved energy or an emission of greenhouse gas that are different from what have been used previously, as information on evidence for issuing credits. In this case, the energy saving effect and the emission of greenhouse gas and the like of the fluid machine 51 before and after the replacement can be determined by using the amount of power consumed and the like by the fluid machine 51 before replacement as the new reference value and the amount of power consumed by the fluid machine 51 after replacement as the post-replacement reference value. In this way, a more accurate saved energy or emission of greenhouse gas can be determined by selecting appropriate rules, specifications and arrangements, thus contributing to reduction in environmental burden.

The credit issuance request unit 33 outputs information on issued credits, such as information on the transaction number, the quantity of credits issued, the date and time of issuance, to the credit management unit 31. The credit management unit 31 writes information on the credits issued by the credit issuance request unit 33 in the account DB 32. More specifically, the credit management unit 31 updates acquisition history 324, discussed later, in the account DB 32. The credit issuance eligibility DB 34 holds a list of changing actions on devices for which credits can be issued. This list can be established on the system administrator side in advance or the results of requests that were made by the credit issuance request unit 33 in past can be stored and learned, thus updating the credit issuance eligibility DB 34. The list may record changing actions for a certain issuance eligibility or for multiple types of credits. The credit issuance eligibility DB 34 can also be said to be a database on changes to devices and such changes cause credits to be issued.

The operation information DB 25 stores measurement data for the fluid machine 51. Since measurement data is time-series data as mentioned above, the measured value of the measuring instrument 52 at each time of day is stored in the operation information DB 25, for example. The operation information DB 25 is updated by the measurement data acquisition unit 21. The device information DB 26 stores overview information for the fluid machine 51. The device information DB 26 may be created in advance or may be rewritten by the administrator of the management system 1.

The contract information DB 27 stores information on a credit transfer contract between the user of the fluid machine 51 and the administrator of the management system 1. The contract information DB 27 may be created in advance or may be rewritten by the administrator of the management system 1. The improvement detection DB 28 stores information for detecting possible improvements in relation to the operation of the fluid machine 51 and presenting solutions. The improvement detection DB 28 may be created in advance or may be rewritten by the administrator of the management system 1. In the account DB 32, information on acquired credits is stored on a per-account basis. Information on credits in the account DB 32 is updated by the credit management unit 31.

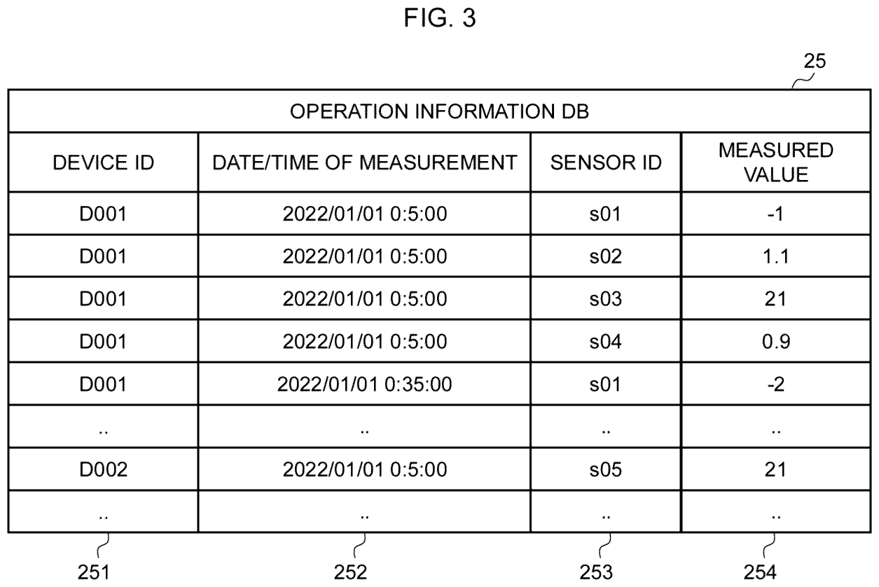

FIG. 3 shows an example of the operation information DB 25. The operation information DB 25 consists of multiple records, each record having the fields of device ID 251, date and time of measurement 252, sensor ID 253, and measured value 254. The device ID 251 is an identifier identifying the fluid machine 51. The date and time of measurement 252 is the date and time the measurement data was measured. The sensor ID 253 is an identifier identifying the measuring instrument 52. For example, a sensor ID “s01” indicates a pressure gauge for measuring the suction pressure of an air compressor, a sensor ID “s02” indicates a flowmeter for measuring the discharge flow rate of the air compressor, a sensor ID “s03” indicates an ammeter for measuring a current flowing in a motor contained in the air compressor, and a sensor ID “s04” indicates a power factor meter for measuring the power factor of power flowing the motor contained in the air compressor. The measured value 254 is a measured value measured by each sensor. The units of measured values are predefined, such as “kPa” for pressure, “m³/min.” for discharge flow rate, “A” for current, and no unit for power factor, for example.

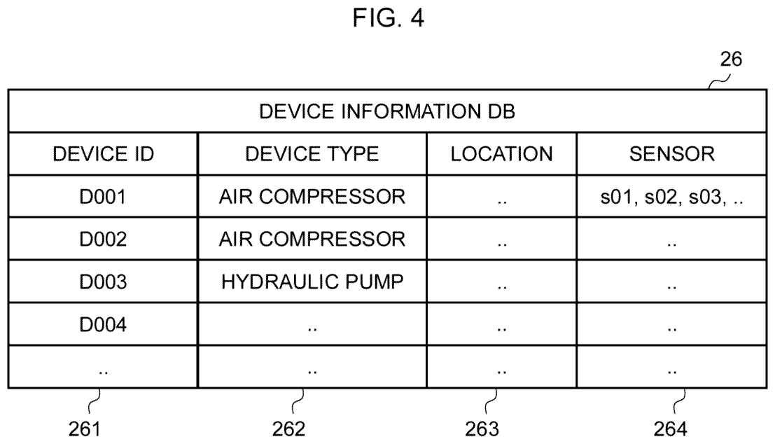

FIG. 4 shows an example of the device information DB 26. The device information DB 26 consists of multiple records, each record having the fields of device ID 261, device type 262, location 263, and sensor 264. The device ID 261 is an identifier identifying the fluid machine 51 and is the same as the device ID 251 in the operation information DB 25. That is, if the device ID 261 and the device ID 251 are of the same value, it means that they are the same fluid machine 51. The device type 262 is the type of the fluid machine 51, having the value of air compressor, hydraulic pump, turbo pump, etc. The location 263 is where the fluid machine 51 is installed. The location 263 may be written in a human understandable form of an address, or as a longitude and a latitude. The sensor 264 is a list of the identifiers of sensors that acquire data on the operation of the fluid machine 51.

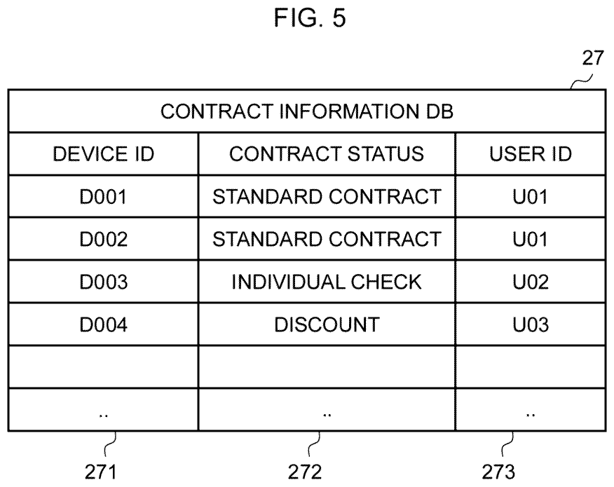

FIG. 5 shows an example of the contract information DB 27. The contract information DB 27 consists of multiple records, each record having the fields of device ID 271, contract status 272, and user ID 273. The device ID 271 is an identifier identifying the fluid machine 51 and is the same as the device ID 251 in the operation information DB 25 and the device ID 261 in the device information DB 26. The contract status 272 is a status regarding the handling of credits that will be generated by the user of the fluid machine 51 to the administrator of the management system 1 in future. For example, the contract status 272 can record “standard contract” in the case of agreeing with standard distribution conditions in a clause of a device monitoring service contract, “individual check” in the case of individually making a check upon an order for an environment improving work such as maintenance, and contract statuses corresponding to other conditions when there are other conditions on distribution and transaction of credits to the system side. However, only eligibility or non-eligibility for credit distribution may be recorded. The user ID 273 is the identifier of the user of the fluid machine 51.

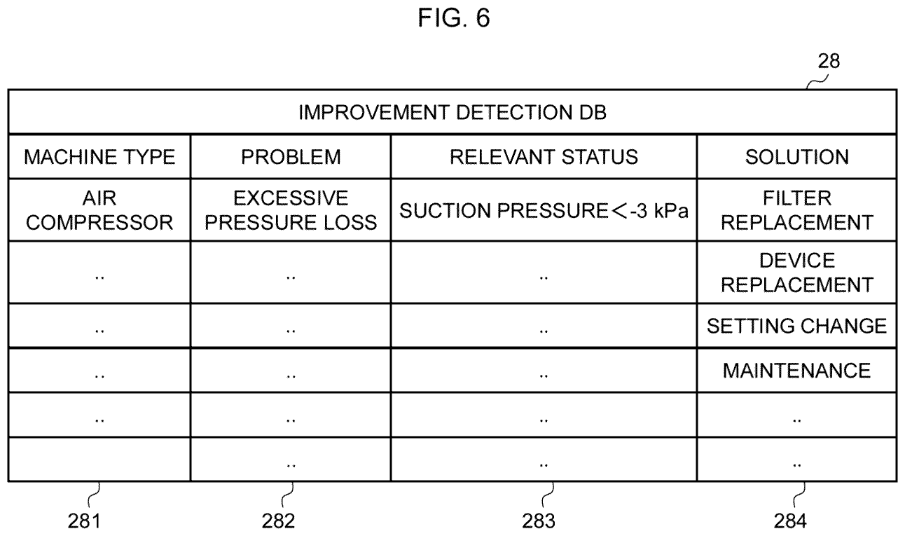

FIG. 6 shows an example of the improvement detection DB 28. The improvement detection DB 28 consists of multiple records, each record having the fields of device type 281, problem 282, relevant status 283, and solution 284. The device type 281 is the type of the fluid machine 51 and is the same as the device type 262 in the device information DB 26. The problem 282 is a label indicative of a problem that should be redressed. The relevant status 283 is a condition for determining that there is a problem occurring. The solution 284 is a way to redress or solve the problem occurring and is used for presentation to the user.

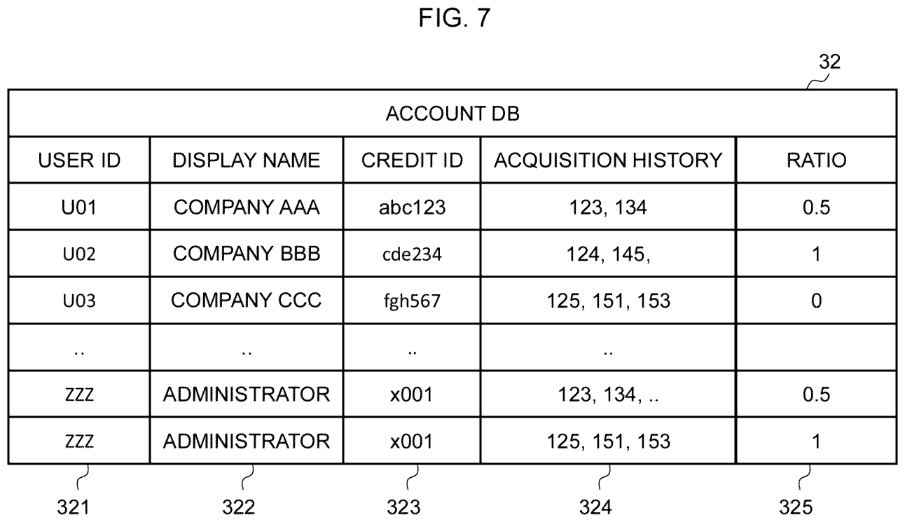

FIG. 7 shows an example of the account DB 32. The account DB 32 consists of multiple records, each record having the fields of user ID 321, display name 322, credit ID 323, acquisition history 324, and ratio 325. The user ID 321 is the identifier of the user of the fluid machine 51 and is the same as the user ID 273 in the contract information DB 27. The display name 322 is the name of the user and is used for presentation to the user. The credit ID 323 is the identifier of the owner of credits managed by the credit issuance system 6 and is the same as the issued-to party 624 in the credit information DB 62. The acquisition history 324 is information showing the history of credits that have been acquired so far; in the example shown in FIG. 7, the value of the transaction number 621 in the credit information DB 62 is used for it. The ratio 325 is the ratio of credits that can be acquired by the user of the fluid machine 51 and the remainder is allocated to the administrator of the management system 1. The account DB 32 can also be said to be a database that accumulates and records issued credits as accounts on a per-user basis. The account DB 32 includes an account for the administrator of the management system 1 in addition to the account for each user of the device.

While in the present embodiment the credits distribution ratio is managed per user ID in the account DB 32, different distribution ratios corresponding to different devices may be set for the same user ID in accordance with the per-device contract status shown in FIG. 5 and computation may be performed based on the distribution ratios.

The first record shown in FIG. 7 indicates that the user ID “U01” is “Company AAA” and its ID in the credit issuance system 6 is “abc123”, and that this user has acquired “0.5”, namely half, of the credits that were acquired for the transaction numbers “123” and “134” in the past. The second record shown in FIG. 7 indicates that the user ID “U02” is “Company BBB” and its ID in the credit issuance system 6 is “cde234”, and that this user has acquired all of the credits that were acquired for transaction numbers “124” in “145” in the past. The user ID “U02” has the ratio 325 of “1” because “individual check” is set in the contract information DB 27. As another example, the user ID “U03” has the ratio 325 of “0” because “discount” is set in the contract information DB 27, which is a contract status where all the credits are transferred to the administrator.

The last two records shown in FIG. 7 are both related to the administrator of the management system 1. For the administrator, there are a fluid machine 51 with the ratio 325 of “0.5” and a fluid machine 51 with the ratio 325 of “1”, so there are two records correspondingly.

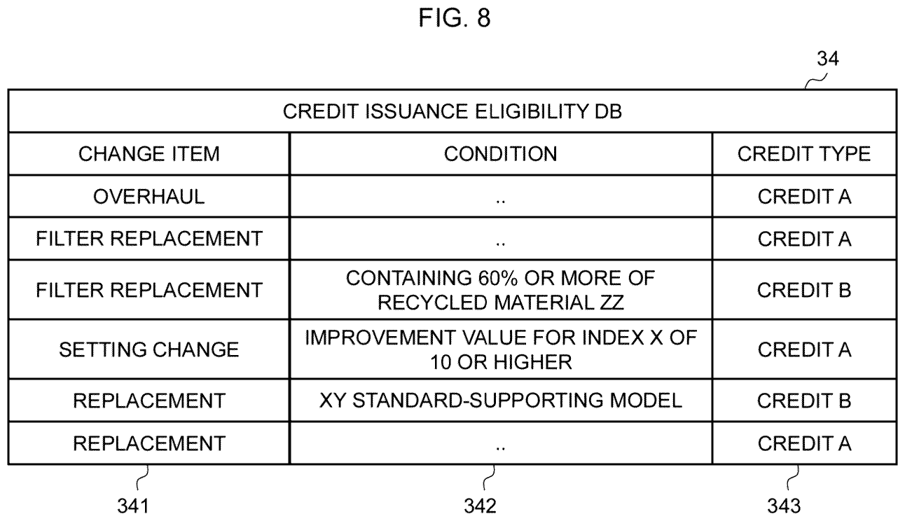

FIG. 8 shows an example of the credit issuance eligibility DB 34. The credit issuance eligibility DB 34 consists of multiple records, each record having the fields of change item 341, condition 342, and credit type 343. The change item 341 is the type of a change made to the fluid machine 51. The condition 342 is a condition for credits to be issued. The credit type 343 is the type of credits issued. The fourth record shown in FIG. 8 indicates that “credit A” will be acquired if a “setting change” is made to the fluid machine 51 and “index x” is improved “10-fold or more”.

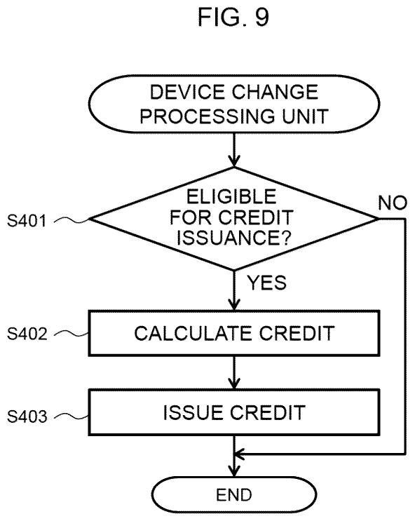

FIG. 9 is a flowchart illustrating the operation of the device change processing unit 20. The device change processing unit 20 executes the process illustrated in FIG. 9 upon a change being made to a machine managed by the remote monitoring apparatus 2. The device change processing unit 20 first determines in step S401 whether the change made is eligible for credit issuance or not in consideration of the credit issuance eligibility DB 34. If it determines that the change is eligible for credit issuance, the device change processing unit 20 proceeds to step S402, and if it determines that the change is not eligible for credit issuance, it ends the process shown in FIG. 9. In step S402, the device change processing unit 20 calculates the credits that can be acquired for the current change using the credit calculation unit 23. In the following step S403, the device change processing unit 20 requests the credit issuance request unit 33 to issue credits and ends the process shown in FIG. 9.

Computation by the index computation unit 22 is now described. Unit consumption A [Yen/m³] is the cost for obtaining one cubic meter of compressed air. Power consumption B [kWh] is the power consumed by the fluid machine 51 per hour. Power unit price C [Yen/kWh] is the price of electric power that is consumed by the fluid machine 51 per hour. Airflow D [m³/h] is the volume of compressed air at a certain pressure. The unit consumption A is then represented by Equation 1:

$$A = B \times C / D \qquad ( Equation 1 )$$

Power consumption B in Equation 1 can be calculated with Equation 2:

$$B = Sqrt ( 3 ) \times I \times V \times ϕ \times ψ \qquad ( Equation 2 )$$

Note that Sart (3) in Equation 2 is the squared root of 3 because Sqrt is an operator to calculate a square root. I in Equation 2 indicates current, for which a measured value for every 30 minutes is used. V in Equation 2 indicates voltage, for which a fixed value as a product specification is used. ϕ in Equation 2 indicates power factor, for which a measured value for every 30 minutes is used. ψ in Equation 2 indicates motor efficiency, which is identified by referencing a known lookup table. Airflow D in Equation 1 is calculated as the product of rated airflow E and load factor F, as shown in Equation 3:

$$D = E \times F \qquad ( Equation 3 )$$

In the equation, the rated airflow E is a specification of the fluid machine 51, representing the airflow that is discharged at a certain pressure per hour. The load factor F is calculated by Equation 4:

$$F = P - Q / ( R - Q ) \qquad ( Equation 4 )$$

In Equation 4, P is the measured current value, Q is unloaded current, and R is full-load current.

The credit calculation unit 23 uses two indices calculated by the index computation unit 22 and a predetermined factor to calculate the credits to be acquired. The two indices calculated by the index computation unit 22 are power efficiency indices before and after an improvement. Information on the date and time when some improvement was made to each fluid machine 51, which is information essential for computation by the credit calculation unit 23, is entered by the administrator of the management system 1. For example, if for a fluid machine 51, the power efficiency index before an improvement is 1.2 [kWh/m³], the power efficiency index after the improvement is 1.1 [kwh/m³], and the annual output required from the fluid machine 51 is 1000 [m³], an annual credit Z that can be acquired is represented by Equation 5, where the predetermined factor is 0.1:

$$Z = ( 1.2 - 1.1 ) \times 1000 \times 0.01 = 10 \qquad ( Equation 5 )$$

The improvement detection unit 24 detects any possible improvement in connection with the operation of the fluid machine 51 (hereinafter an “improvable feature”) by referencing the operation information DB 25 and the improvement detection DB 28. The improvement detection unit 24 may detect an improvable feature based on whether a relevant status 282 indicated in the improvement detection DB 28 applies or not, or may detect an improvable feature using any of various known approaches. Upon detecting a possible improvement, the improvement detection unit 24 calculates a means of improvement, an estimated amount of change in assessment value, an estimated amount of change in power consumption, and an estimated quantity of credits that can be acquired. A measured value after the improvement that is expected to be achieved by the means of improvement may be determined using past data stored in the operation information DB 25.

The UI generation unit 29 generates a user interface for presentation to the user using information stored in the operation information DB 25, the device information DB 26, the contract information DB 27 and the improvement detection DB 28, and the results of calculation by the credit calculation unit 23 and the improvement detection unit 24. For example, the UI generation unit 29 identifies the user for which information should be provided, identifies the device ID associated with the user ID of the user from the contract information DB 27, further retrieves all the records that have the device ID from the operation information DB 25, and outputs the measured values of sensors as a time-series graph. The UI generation unit 29 also functions as a change presentation unit that presents the user with a change to the device and the credits that can be acquired for the change and as a presentation unit that presents the user with a purchase interface for using credits that will be acquired in the future for purchasing an article related to the device.

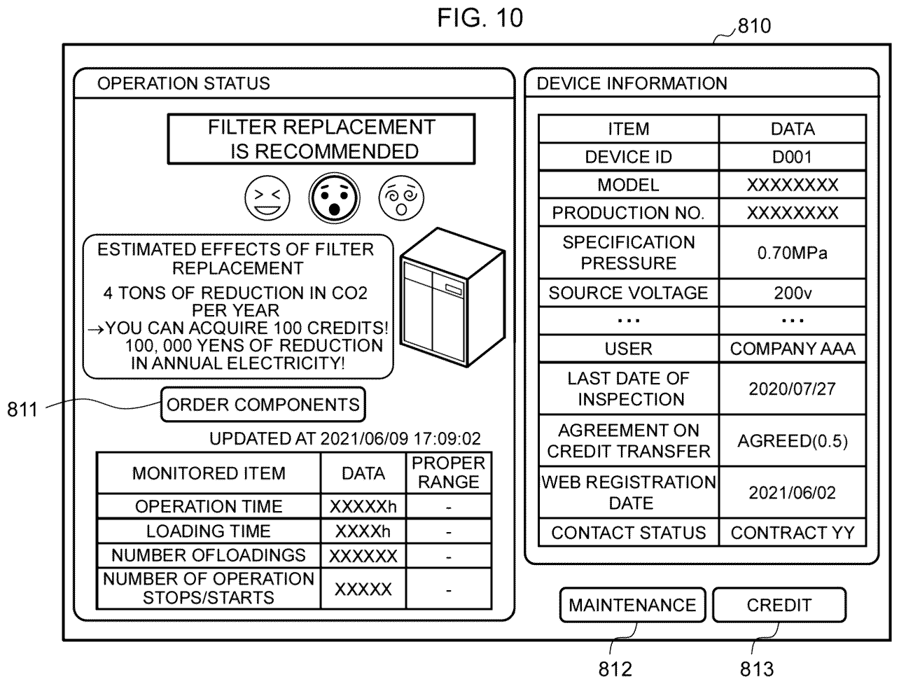

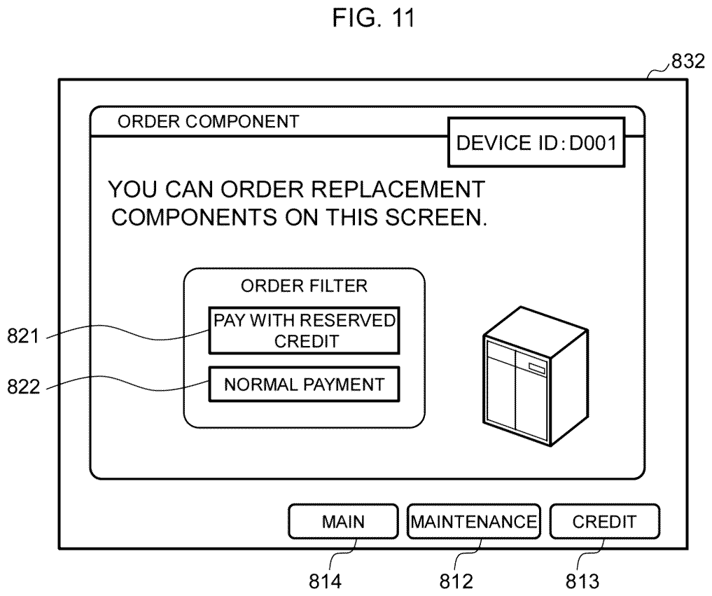

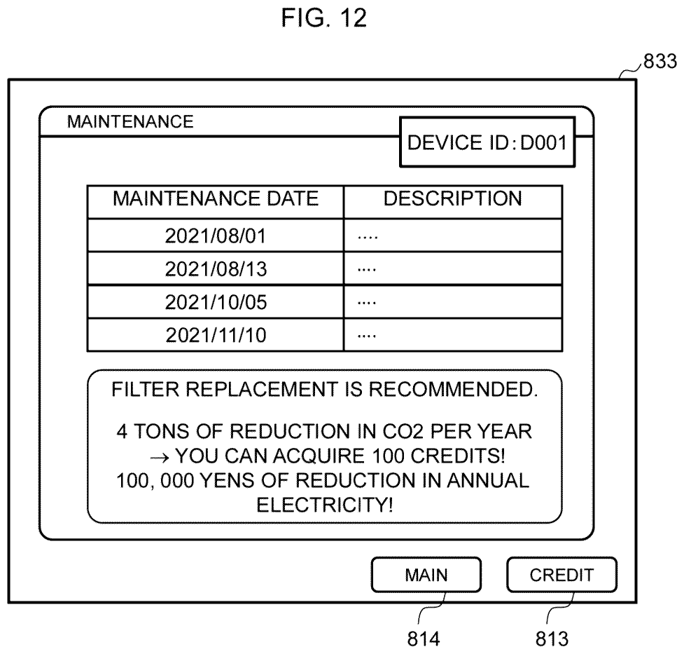

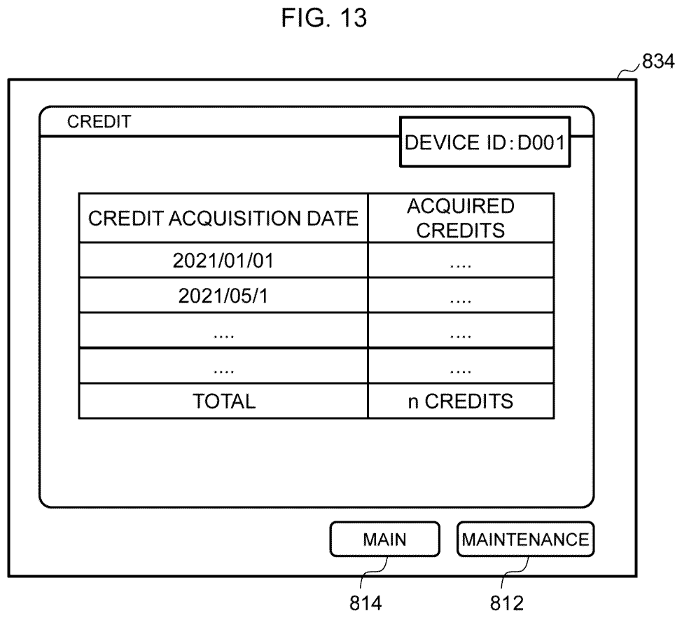

FIG. 10 shows an exemplary screen 810 generated by the UI generation unit 29, displaying operation status and device information. The screen shown in FIG. 10 is also called a “main screen” below. The UI generation unit 29 displays problems detected by the improvement detection unit 24, the means of improvement, and the credits and/or an amount of reduction in electricity cost that would result from the improvement. This exemplary screen 810 is displayed on the user terminal 4 of the user representing the “Company AAA” which uses the fluid machine 51 with the device ID of “D001”. When the user presses the “Order components” button indicated by reference numeral 811, the screen switches to the screen of FIG. 11, discussed later. When the user presses the “Maintenance” button indicated by reference numeral 812, the screen switches to the screen of FIG. 12, discussed later. When the user presses the “Credit” button indicated by reference numeral 813, the screen switches to the screen of FIG. 13, discussed later.

FIG. 11 shows an exemplary screen 832 generated by the UI generation unit 29, displaying a component order screen. This screen has a “Payment with reserved credit” button indicated by reference numeral 821 and a “Normal payment” button indicated by reference numeral 822, and an air filter as a component of the fluid machine 51 is ordered whichever button the user presses. If the user presses the “Payment with reserved credit” button indicated by reference numeral 821, the price of the air filter is paid with credits that will be acquired in future, not with monetary currency. Alternatively, there may be an option of payment for which a discount with combination of credits and monetary currency can be obtained. Alternatively, payment can be made with already acquired credits. The relationship between monetary currency and credit is defined separately. When the user presses the “Normal payment” button indicated by reference numeral 822, the air filter is paid for with monetary currency. The payment in this case may be a predefined credit sale or may use a registered credit card. The “Maintenance” and “Credit” buttons among the three buttons shown in the lower right portion of FIG. 11 were described in FIG. 10. When the user presses the “Main” button indicated by reference numeral 814, the screen switches to the screen of FIG. 10.

FIG. 12 shows an exemplary screen 833 generated by the UI generation unit 29, displaying a maintenance history screen. This screen shows history of maintenance for a particular fluid machine 51 and the results of calculation by the improvement detection unit 24. The two buttons shown in the lower right portion of FIG. 12 were described in FIGS. 10 and 11.

FIG. 13 shows an exemplary screen 834 generated by the UI generation unit 29, displaying a credit screen. This screen shows the credits that have been acquired by a particular fluid machine 51 until now. However, the acquired credits may also be indicated on a per-user basis, instead of per fluid machine 51. The two buttons shown in the lower right portion of FIG. 13 were described in FIGS. 10 and 11.

According to the first embodiment described above, the following effects are provided:

(1) The management system 1 includes: a measurement data acquisition unit 21 that acquires measurement data, the measurement data being time-series data related to operation of a fluid machine 51; an index computation unit 22 that computes an index based on the measurement data; a credit calculation unit 23 that compares the index before and after a change is made to the fluid machine 51 and calculates credits as compensation for reducing an emission of greenhouse gas; and a credit management unit 31 that associates part of the calculated credits with a user of the device. The credit management unit 31 associates part of the calculated credits with the operator of the management system 1. This creates incentive to reduce the emission of greenhouse gas also for parties other than the user of the fluid machine 51, which can thus promote reduction in the emission of greenhouse gas.

(2) The remote monitoring apparatus 2 included in the management system 1 is a platform for an after-sales monitoring service on the fluid machine 51. Thus, credits that can be acquired for an environmental improvement can be issued to promote suppression of greenhouse gas emission based on measurement data for the device that needs to be acquired for monitoring of the fluid machine 51 and using a measurement databased on a cloud constructed for device monitoring.

(3) The measurement data is data that is obtained from periodical measurement. Thus, credits can be calculated using periodically acquired data.

(4) The measurement data is data that is obtained from measurement at a cycle of once every 30 minutes or more.

(5) The device under management of the management system 1 is a fluid machine 51 and the time-series data related to the operation of the device is time-series data on a current value of the fluid machine 51. Thus, time-series data on the current value can be used to calculate power consumption.

(6) The device under management of the management system 1 is an air compressor and the time-series data related to the operation of the device is time-series data on an output airflow of the air compressor. Thus, various indices for the fluid machine 51 can be calculated using the output airflow.

(7) The device under management of the management system 1 is a fluid machine and the time-series data related to the operation of the device is time-series data on a volume or a mass of fluid ejected by the fluid machine. For the fluid machine 51, the discharge flow rate is an important parameter related to its operation and various indices can be calculated using the discharge flow rate.

(8) The device is an air compressor and the change to the device is replacement of an air filter contained in the air compressor. Thus, by reducing pressure loss in the filter to improve power efficiency, the emission of greenhouse gas can be reduced.

(9) A change to the fluid machine 51 includes replacement of the device. Thus, by replacing the device with a new device of the same kind, aging and different causes of reduced power efficiency that occurred during use can be eliminated to improve power efficiency, the emission of greenhouse gas can be reduced.

(10) The change to the fluid machine 51 includes a change to a setting related to the operation of the device. Thus, by changing the device settings to appropriate ones to improve power efficiency, the emission of greenhouse gas can be reduced.

(11) The change to the fluid machine 51 includes maintenance of the device. Thus, by improving power efficiency through maintenance, the emission of greenhouse gas can be reduced. Examples of maintenance include partial replacement of components, thread fastening, and oiling. Improved operation as a result of component replacement, reduced vibration around screw fastening points, better mechanical transmission force and the like can be expected.

(12) For the credits related to the device of the user for which a predefined agreement has been obtained, the credit management unit 31 associates part of the credits with the user, and for the credits related to the device of the user for which the predefined agreement has not been obtained, it associates all of the credits with the user. Thus, credits can be accumulated reflecting the intension of the user of the fluid machine 51.

(13) The UI generation unit 29 also functions as a change presentation unit that presents the user with a change to the device and the credits that can be acquired for the change.

(14) The UI generation unit 29 further functions as a presentation unit that presents the user with a purchase interface for using the credits that will be acquired in future for purchasing an article related to the device, as shown in FIG. 11.

(15) The management system 1 includes credit issuance request unit 33 that transmits information on the device to the credit issuance system 6 at which the credits are issued and acquires the credits.

### (First Variation)

The UI generation unit 29 may also generate a user interface that allows the user of the fluid machine 51 to select whether or not to agree to transfer part of the credits that will be acquired in the future to the administrator of the management system 1.

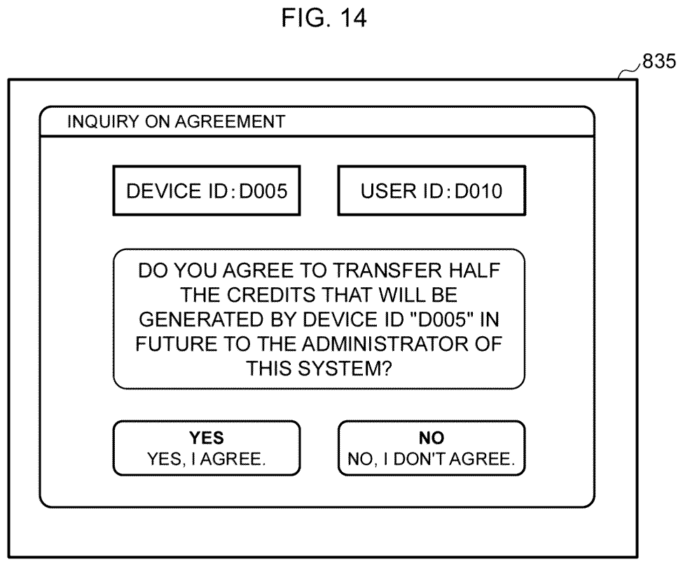

FIG. 14 shows an example of an agreement screen 835 that is generated by the UI generation unit 29 in a first variation. The agreement screen 835 has Yes and No options; if the user selects Yes, contract status 272 in the contract information DB 27 is updated by the UI generation unit 29, such that “standard contract” is recorded, for example.

This variation provides the following effect. (16) The management system 1 includes a user interface that allows the user to select whether to accept the predefined agreement or not. Thus, an agreement can be obtained on the management system 1 without the need to obtain an agreement from the user in advance.

### (Second Variation)

In the above-described embodiment, the credits that are acquired are divided between the user and the administrator of the management system 1. However, the credits that are acquired may also be divided between the two parties of the user and the manufacturer of the fluid machine 51, or may be divided among the three parties of the user, the administrator of the management system 1, and the manufacturer of the fluid machine 51. The party to which the credits that are acquired can be distributed may be the account of a stakeholder other than the user and the administrator of the management system, such as an investor for the installation of the device, for example. Furthermore, the ratio of credits to be divided between the user and the other party is not limited to 1:1, but may be set to any ratio.

The ratio of distribution may also be determined in accordance with the degree of contribution to an environmental improvement index that is provided by a changing action on the device. As an example, for replacement a filter of a fluid machine, 1 may be distributed to the user who invested money in it. For a changing action with introduction of new settings for a device, 0.5 may be distributed to each of the manufacturer of the device who derived the device settings and the user. As another example, using data accumulated through a device monitoring service, an improvement in operation time that results from the way of using the device by the user and an improvement that results from overhauling and the like may be separately calculated and the ratio of distribution may be determined based on them. The ratio of distribution can be set higher for a user who performs more frequent component replacement and maintenance of the device being used by the user than a user who performs them less frequently, or for a user who can contribute to energy saving more by performing component replacement or maintenance earlier than originally scheduled. By doing so, incentive to operate devices in conditions with less environmental burden can be created, thus improving the energy saving efficiency of the actual devices. The ratio of distribution described above can be arranged with the administrator of the management system or the like before use of the device is started, at the start, or during use. Making such an arrangement around the start of use of the device is effective because the device user is motivated to operate the device so as to increase the energy efficiency for the device or to lessen the generation of greenhouse gas.

The configuration of the functional blocks is merely an example in the embodiments and variations described above. Several functional components shown as separate functional blocks may be integrally configured or components shown in one functional block diagram may be separated into two or more functions. In addition, some of the functions provided by each functional block may be provided by other functional blocks.

While the foregoing embodiments were described in the context of a fluid machine, the present invention may be applied to other industrial devices that are capable of measuring input energy and output energy. For example, the present invention may be applied to industrial devices that convert electric power such as transformers or industrial devices that incorporate motors, engines and the like and convert electric power or chemical energy to mechanical motion energy.

The present invention may be also applied to issuance of credits that contribute to environmental market value or reduction in environmental burden other than credits that are related to emission of greenhouse gas, including carbon.

### REFERENCE SIGN LIST

1 . . . management system
2 . . . remote monitoring apparatus
3 . . . credit processing apparatus
4 . . . user terminal
5 . . . operation site
6 . . . credit issuance system
21 . . . measurement data acquisition unit
22 . . . index computation unit
23 . . . credit calculation unit
24 . . . improvement detection unit
25 . . . operation information database
26 . . . device information database
27 . . . contract information database
28 . . . improvement detection database
29 . . . UI generation unit
31 . . . credit management unit
32 . . . account database
33 . . . credit issuance request unit
34 . . . credit issuance eligibility database
51 . . . fluid machine
52 . . . measuring instrument

1. A management system comprising:
a measurement data acquisition unit that acquires measurement data, the measurement data being time-series data related to operation of a device;
an index computation unit that computes an index based on the measurement data;
a credit calculation unit that compares the index before and after a change is made to the device and calculates credits as compensation for reducing an emission of greenhouse gas; and
a credit management unit that associates part of the calculated credits with a user of the device,
wherein the credit management unit associates part of the calculated credits with an operator of the management system or a producer of the device.

2. The management system according to claim 1, wherein the management system is a platform for a monitoring service on the device, and the measurement data includes data that is used in monitoring of an operation status of the device.

3. The management system according to claim 1, wherein the measurement data is data that is obtained from periodical measurement.

4. The management system according to claim 1, wherein the measurement data is data that is obtained from measurement at a cycle of once every 30 minutes or more.

5. The management system according to claim 1, wherein
the device is a fluid machine, and
the time-series data related to the operation of the device is time-series data on a current value of the fluid machine.

6. The management system according to claim 1, wherein
the device is an air compressor, and
the time-series data related to the operation of the device is time-series data on an output airflow of the air compressor.

7. The management system according to claim 1, wherein
the device is a fluid machine, and
the time-series data related to the operation of the device is time-series data on a volume or a mass of fluid ejected by the fluid machine.

8. The management system according to claim 1, wherein
the device is an air compressor, and
the change to the device is replacement of an air filter contained in the air compressor.

9. The management system according to claim 1, wherein the change to the device is replacement of the device.

10. The management system according to claim 1, wherein the change to the device is a change to a setting related to the operation of the device.

11. The management system according to claim 1, wherein the change to the device is maintenance of the device.

12. The management system according to claim 1, wherein
for the credits related to the device of the user for which a predefined agreement has been obtained, part of the credits is associated with the user, and
for the credits related to the device of the user for which the predefined agreement has not been obtained, all of the credits are associated with the user.

13. The management system according to claim 12, further comprising a user interface that allows the user to select whether to accept the predefined agreement or not.

14. The management system according to claim 1, further comprising a change presentation unit that presents the user with a change to the device and the credits that can be acquired for the change.

15. The management system according to claim 1, further comprising a presentation unit that presents the user with a purchase interface for using the credits that will be acquired in future for purchasing an article related to the device.

16. The management system according to claim 1, further comprising a credit issuance request unit that transmits information on the device to a credit issuing body at which the credits are issued, and acquires the credits.

17. The management system according to claim 1, comprising a database related to changes to the device for which the credits can be issued.

18. The management system according to claim 1, comprising a database that accumulates and records the issued credits as accounts on a per-user basis, and
the database includes an account for the management system in addition to the account for each user of the device.
